(19) United States
(12) Patent Application Publication
(10) Pub. No.: US 2005/0150900 A1
(43) Pub. Date: Jul. 14, 2005

(54) Beverage can dispenser

(75) Inventors: Robert M. Byrne, Lima, OH (US); Bret Kline, Columbus, OH (US)

Correspondence Address: RANKIN, HILL, PORTER & CLARK, LLP, 925 EUCLID AVENUE, SUITE 700, CLEVELAND, OH, 44115-1405, US

(73) Assignee: American Trim, L.L.C., Lima, OH (US)

(21) Appl. No.: 10/754,440

(22) Filed: Jan. 9, 2004

(51) Int. Cl. B65H 3/00; G07F 11/16; B65G 59/00

(52) U.S. Cl. 221/266

(57) ABSTRACT

The present invention provides a beverage can dispenser for a refrigerator that includes a chute disposed within an interior portion of the refrigerator that is adapted to receive and hold a plurality of beverage cans in a side-by-side relationship for sequential discharge from a bottom end of the chute. The dispenser further includes a rotatable drum that has a trough portion adapted to receive a beverage can discharged from the bottom end of the chute and a barrel portion adapted to sealingly fill an opening provided through a door of the refrigerator when positioned adjacent thereto. The drum is rotatable from a first position where the barrel portion of the drum is adjacent to the opening provided through the door to a second position where the trough portion of the drum is adjacent to the opening through the door to permit removal of a beverage can from the trough.

### BACKGROUND OF THE INVENTION

1. Field of Invention

The present invention relates to a beverage can dispenser and, more particularly, to a beverage can dispenser for dispensing refrigerated beverage cans through a door of a refrigerator.

2. Description of Related Art

Many devices are known for individually dispensing refrigerated beverage cans. Vending machines, for example, accept coins or other forms of payment and then electro-mechanically discharge a refrigerated beverage can into a basket for retrieval by a consumer. Other known beverage can dispensers simply consist of refrigerated cabinets having doors that swing open or slide open to allow a consumer to retrieve a beverage can from a shelf or a gravity-fed dispensing rack situated within the cabinet.

Electro-mechanically operated devices are expensive, and can be somewhat complicated to load with beverage cans. Refrigerated cabinets with swinging or sliding doors are generally less expensive than electro-mechanically operated beverage can dispensing devices and are easier to load, but they tend to be substantially less energy efficient because they allow refrigerated air to escape each time the door is opened by a consumer to retrieve a beverage can from the cabinet. A non-electromechanical beverage can dispenser that provides the simplicity of a refrigerated cabinet, but does not allow large amounts of refrigerated air to escape each time a beverage can is dispensed, is needed.

### BRIEF SUMMARY OF THE INVENTION

The present invention provides a beverage can dispenser that comprises a chute disposed within an interior portion of a refrigerator that is adapted to receive and hold a plurality of beverage cans in a side-by-side relationship for sequential discharge from a bottom end of the chute. The dispenser further comprises a rotatable drum having a trough portion adapted to receive a beverage can discharged from the bottom end of the chute and a barrel portion adapted to sealingly fill an opening provided through a door of the refrigerator when positioned adjacent thereto. The drum is rotatable from a first position, where the barrel portion of the drum is adjacent to the opening provided through the door, to a second position, where the trough portion of the drum is adjacent to the opening through the door, to permit removal of a beverage can from the trough. To dispense a beverage can through the door of the refrigerator, a user rotates the drum until the beverage can-supporting trough is positioned adjacent to the opening through the refrigerator door. The user removes the beverage can from the trough and then releases the drum, which is preferably biased to rotate back to a position where the barrel portion sealingly fills the opening provided through the refrigerator door.

In one preferred embodiment of the invention, the beverage can dispenser includes a chute that is connected to or integrally formed on the interior side of the door of the refrigerator. In this embodiment, the chute holds and maintains a plurality of beverage cans in a substantially vertical side-by-side stack. Individual beverage cans are sequentially discharged from the chute into the trough portion of the rotatable drum, which is also preferably mounted to the refrigerator door, using the force of gravity. No electro-mechanical force is needed to dispense the beverage can through the refrigerator door to the user.

In another preferred embodiment of the invention, the beverage can dispenser includes a chute that is supported by or constitutes a shelf structure within the interior of the refrigerator. In this embodiment, the chute holds and maintains a plurality of beverage cans in a near-horizontal low-angle serpentine stack for discharge into the trough of a rotatable drum. The rotatable drum can be mounted to the shelf structure for engagement with an opening in the refrigerator door when the refrigerator door is closed or, alternatively, the rotatable drum can be mounted to the refrigerator door for engagement with the discharge end of the chute when the refrigerator door is closed.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is front perspective view of a refrigerator provided with a beverage can dispenser according to the present invention.

FIG. 2 is a perspective view of a portion of the refrigerator shown in FIG. 1 with the refrigerator door in an open position.

FIG. 3 is an exploded detail perspective view of the beverage can dispenser shown in FIG. 2.

FIG. 4 is a schematic side view of a rotatable drum portion of a beverage can dispenser according to the invention in a first position.

FIG. 5 is a schematic side view of the rotatable drum portion of the beverage can dispenser shown in FIG. 5 after it has been rotated to a second position.

FIG. 6 is a perspective view of another embodiment of a beverage can dispenser according to the invention.

### DETAILED DESCRIPTION OF THE INVENTION

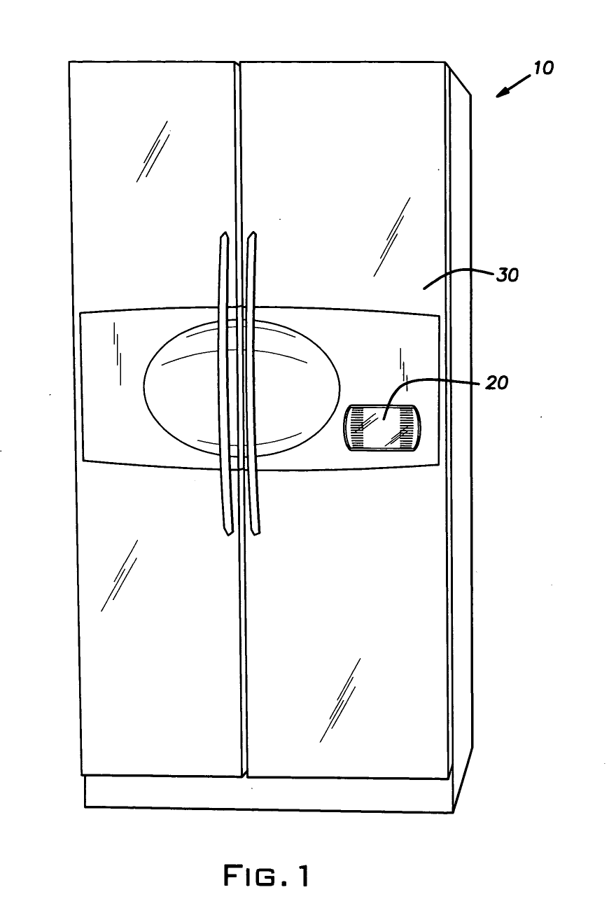

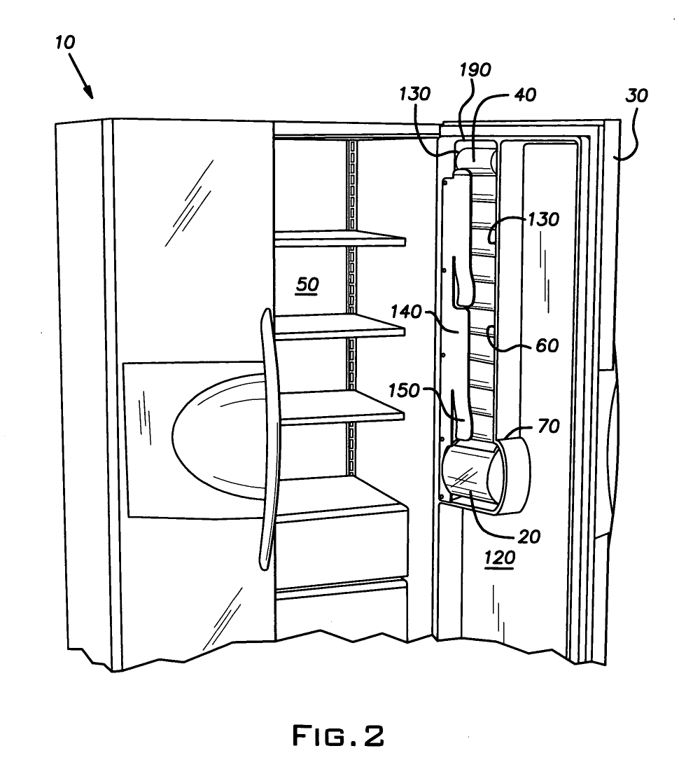

FIG. 1 shows a front perspective view of a refrigerator 10 provided with a beverage can dispenser 20 according to the present invention. FIG. 2 shows a perspective view of a portion of the refrigerator 10 shown in FIG. 1, with the refrigerator door 30 in an open position. The beverage can dispenser 20 according to the invention allows a user to retrieve a refrigerated beverage can 40 from an interior portion 50 of the refrigerator 10 without opening the door 30.

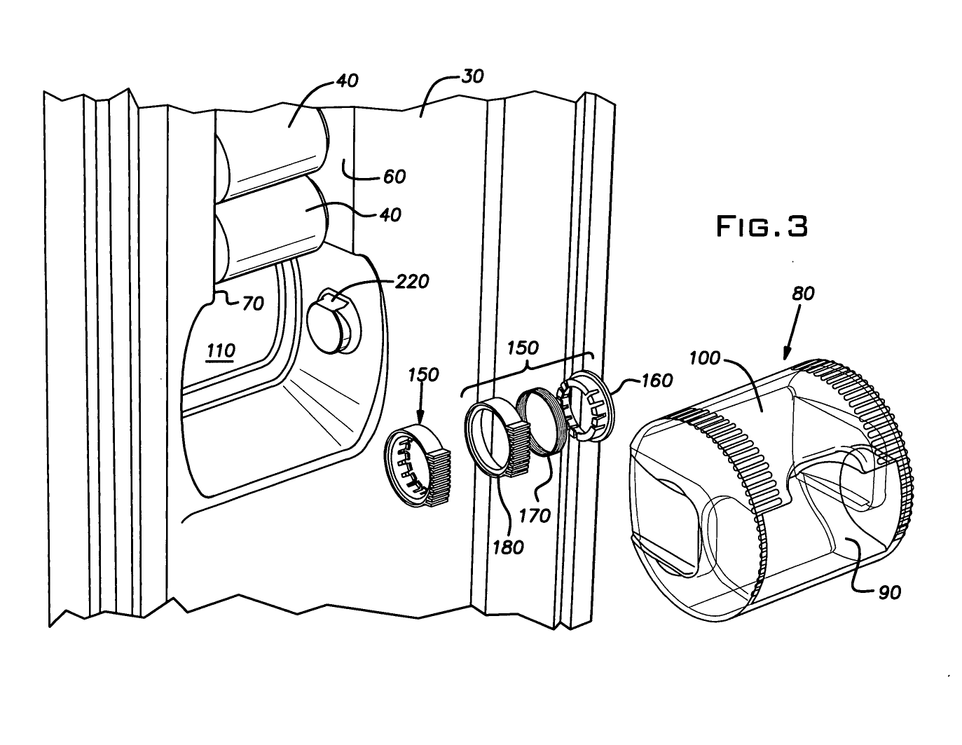

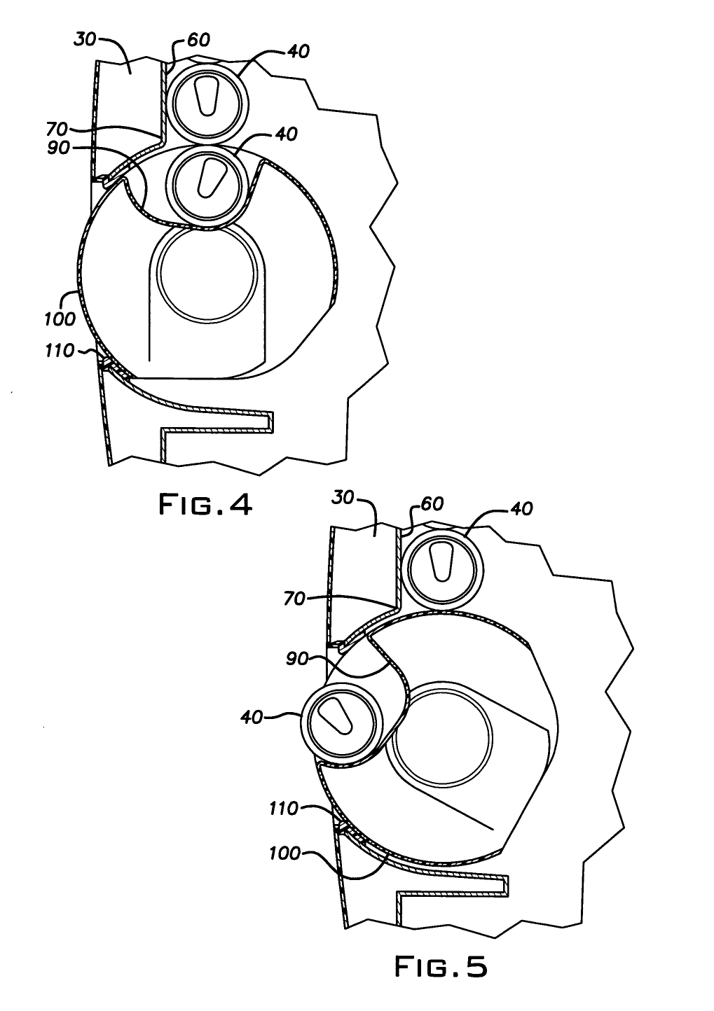

With reference to FIG. 3, which shows an exploded detail perspective view of the beverage can dispenser 20 shown in FIG. 2, a beverage can dispenser 20 according to the invention comprises a chute 60 that is disposed within the interior portion 50 of a refrigerator 10. The chute 60 is adapted to receive and hold a plurality of beverage cans 40 in a side-by-side relationship for sequential discharge from a bottom end 70 of the chute 60. The beverage can dispenser 20 further comprises a rotatable drum 80 having a trough portion 90 and a barrel portion 100. The trough portion 90 is adapted to receive a beverage can 40 discharged from the bottom end 70 of the chute 60. The barrel portion 100 is adapted to sealingly fill an opening 110 provided through the refrigerator door 30 when the barrel portion 100 is in a first position adjacent to the opening 110, as is schematically shown in FIG. 4. The rotatable drum 80 must be rotatable from the first position to a second position, such as is schematically shown in FIG. 5, where the trough portion 90 of the rotatable drum 80 is positioned adjacent to the opening 110 through the door 30 in order to permit removal of a beverage can 40 from the trough portion 90. One or more gaskets can be provided around the periphery of the opening 110 insure that a good seal is formed between the barrel portion 100 of the rotatable drum 80 and the opening 110, which prevents the escape of cold air from an interior portion 50 of the refrigerator 10. A plurality of knurls 230 can optionally be provided on the surface of the rotatable drum 80 to provide a structure a user may grip in order to rotate the rotatable drum 80.

In the embodiment of the invention shown in FIG. 2, the chute 60 extends vertically along an interior surface 120 of the refrigerator door 30. The chute 60 can be formed between two spaced-apart walls 130 projecting from the interior surface 120 and one or more plates 140 that extend from at least one of the panels 130, such as shown in FIG. 2. The chute 60 preferably has generally rectangular shape in cross-section that is sized to accommodate standard size twelve-ounce (355 ml) beverage cans 40. The plates 140 preferably include one or more fingers 150 that extend into the chute 60 to frictionally retard the rate at which a beverage can 40 that is dropped into the chute 60 falls.

With reference to FIG. 3, the rotatable drum 80 preferably rotates on a pair of bearing assemblies 150. In the preferred embodiment of the invention, the bearing assemblies 150 include an annular fixed hub 160, a torsion spring 170 disposed on the annular fixed hub 160, and a rotating annular ring 180 that fits over the torsion spring 170 and mates with the annular fixed hub 160. The torsion spring 170 is preferably biased to return the rotatable drum to a first position where the barrel portion 100 is positioned adjacent to the opening 110 in the door 30. One or more stops (not shown) can be formed on the rotatable drum 80 and/or on the door 30 to limit the range of rotation of the rotatable drum 80.

In the embodiment of the invention illustrated in FIG. 2, the chute 60 is disposed on the door 30 and holds a plurality of beverage cans 40 in a substantially vertical side-by-side orientation for sequential discharge from the bottom end 70 of the chute 60. The chute 60 can be a separate component that is attached to the door 30 or all or some of the chute 60 can be integrally formed as part of the door 30. B verage cans 40 can be loaded into the chute 60 from a top end 190. The fingers 150 extending into the chute 60 retard the rate at which the beverage cans 40 fall down from the top end 190 of the chute 60 to the bottom end 70 of the chute 60. Preferably, the chute 60 has sufficient capacity to hold at least twelve beverage cans 40 at one time.

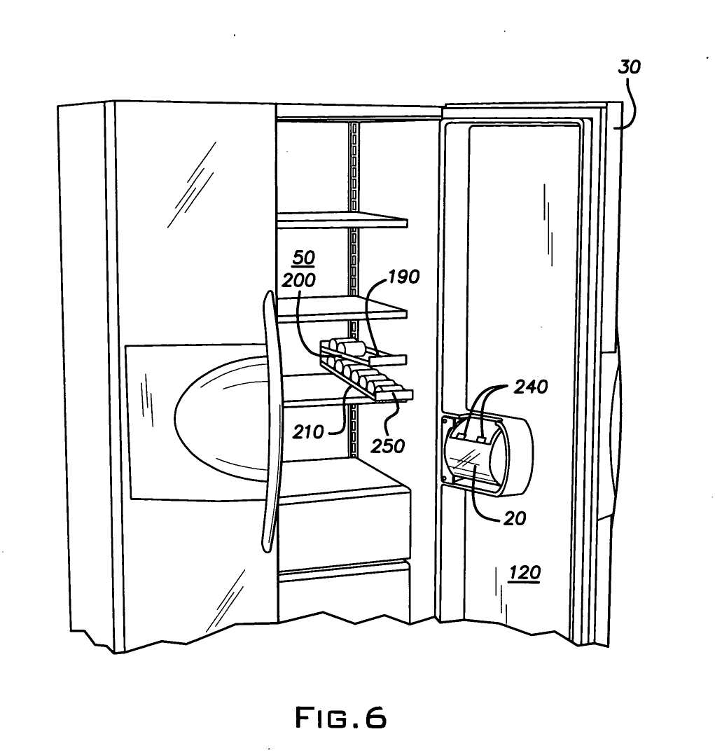

It will be appreciated that the chute 60 does not have to be formed on the door 30 of the refrigerator 10. In the alternative embodiment of the invention illustrated in FIG. 6, the chute 60 is formed as a shelf-type structure within the interior portion 50 of the refrigerator 10. The chute 60 holds a plurality of beverage cans 40 in a serpentine side-by-side stack. Beverage cans 40 loaded into the top end 190 of the chute roll down a first relatively low angle incline 200 toward a rear part of the refrigerator 10 then drop into and roll down a second relatively low angle incline 210 toward the bottom end 70 of the chute 60. Tabs 240 can be provided on the rotatable drum 80 for depressing a hinged stop bar 250 that keeps the beverage cans 40 from falling out of the chute 60 when the refrigerator door 30 is open. The serpentine arrangement of the chute 60 is presently most preferred because beverage cans 40 do not have to be raised as high to be loaded into the chute 60 and because the beverage cans 40 slowly roll, as opposed to fall, toward the bottom end 70 of the chute 60. A chute 60 of this type also preferably accommodates twelve or more beverage cans 40 at a time and allows for the removal of beverage cans 40 from the refrigerator 10 when the refrigerator door 30 is open.

In the embodiment illustrated in FIG. 3, the rotatable drum 80 is mounted on a pair of bearing assemblies 150, each of which is supported by a pin 220 that projects from the door 30. However, it will be appreciated that the rotatable drum 80 need not be connected to the door 30 of the refrigerator. The rotatable drum 80 can alternatively be mounted to a separate support structure within the interior portion 50 of the refrigerator 10. It is only critical that the bottom end 70 of the chute 60 be properly aligned with respect to the trough portion 90 of the rotatable drum 80 when the door 30 of the refrigerator 10 is closed.

The beverage can dispenser 20 according to the invention r duces the amount of space taken up within a refrigerator 10 to store beverage cans 40. Moreover, the beverage can dispenser 20 according to the invention facilitates the sequential removal of one beverage can 40 at a time without requiring the door 30 of the refrigerator 10 to be opened. Thus, the beverage can dispenser 20 according to the invention reduces the number of times the refrigerator door 30 must be opened per day, which saves energy.

Another advantage realized by the beverage can dispenser 20 according to the invention is that it does not require the use of electro-mechanical devices in order to operate. A user loads beverage cans 40 into the chute 60 to be refrigerated. Once the beverage cans 40 have been loaded into the chute 60, the user closes the refrigerator door 30. The beverage can dispenser 20 is thus charged and ready for use. To dispense a beverage can 40, the user rotates, if necessary, the rotatable drum 80 until a beverage can 40 is discharged from the bottom end 70 of the chute 60 into the trough portion 90 of the rotatable drum 80. Once a beverage can 40 is received within the trough portion 90, the user rotates the rotatable drum 80 until the trough portion 90 of the rotatable drum is exposed through the opening 110 in the door 30. At that point, the user can retrieve the beverage can 40 from the trough portion 90 and then release or let go of the rotatable drum 80. Preferably, the rotatable drum 80 is supported by bearing assemblies 150 that are biased to return the rotatable drum 80 back to a first position where the barrel portion 100 contacts and seals off the opening 110. No electro-mechanical devices of any type are needed to dispense a beverage can 40 from the interior portion 50 of the refrigerator 10 to the user.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

1. A beverage can dispenser comprising:
a chute disposed within an interior portion of a refrigerator, the chute being adapted to receive and hold a plurality of beverage cans in a side-by-side relationship for sequential discharge from a bottom end of the chute; and
a rotatable drum comprising a trough portion adapted to receive a beverage can discharged from the bottom end of the chute and a barrel portion adapted to sealingly fill an opening provided through a door of the refrigerator when positioned adjacent thereto, the drum being rotatable from a first position where the barrel portion of the drum is adjacent to the opening provided through the door to a second position where the trough portion of the drum is adjacent to the opening through the door to permit removal of a beverage can from the trough.

2. The beverage can dispenser according to claim 1 wherein the chute is disposed on an interior side of the refrigerator door.

3. The beverage can dispenser according to claim 1 wherein the rotatable drum is disposed on the refrigerator door.

4. The beverage can dispenser according to claim 2 wherein the rotatable drum is also disposed on the interior side of the refrigerator door.

5. The beverage can dispenser according to claim 1 wherein the chute holds a plurality of beverage cans in a serpentine side-by-side stack.

6. The beverage can dispenser according to claim 2 wherein the chute holds a plurality of beverage cans in a substantially vertical side-by-side stack.

7. The beverage can dispenser according to claim 7 further comprising one or more fingers extending into the chute for retarding the rate at which a beverage can dropped into the chute falls.

8. The beverage can dispenser according to claim 1 wherein the rotatable drum rotates on spring-loaded bearings that are biased to return the rotatable drum to the first position from the second position.

9. The beverage can dispenser according to claim 1 comprising no motorized or electrified parts.

10. A refrigerator having a beverage can dispenser comprising:
a chute disposed within an interior portion of a refrigerator, the chute being adapted to receive and hold a plurality of beverage cans in a side-by-side relationship for sequential discharge from a bottom end of the chute; and
a rotatable drum comprising a trough portion adapted to receive a beverage can discharged from the bottom end of the chute and a barrel portion adapted to sealingly fill an opening provided through a door of the refrigerator when positioned adjacent thereto, the drum being rotatable from a first position where the barrel portion of the drum is adjacent to the opening provided through the door to a second position where the trough portion of the drum is adjacent to the opening through the door to permit removal of a beverage can from the trough.
